(19) United States
(12) Patent Application Publication
(10) Pub. No.: US 2026/0307253 A1
(43) Pub. Date: Oct. 8, 2026

(54) AUTONOMOUS MOBILE ROBOT PACE MANAGEMENT SYSTEM

(71) Applicant: GM GLOBAL TECHNOLOGY OPERATIONS LLC, Detroit, MI (US)

(72) Inventors: Macey Salyer, Berkley, MI (US); James Butterworth, Mount Clemens, MI (US); Jesse Heidrich, Shelby Township, MI (US); Joshua Lee Solomon, Berkley, MI (US); Jeffrey Mulnix, Linden, MI (US)

(73) Assignee: GM GLOBAL TECHNOLOGY OPERATIONS LLC, Detroit, MI (US)

(21) Appl. No.: 19/172,448

(22) Filed: Apr. 7, 2025

(51) Int. Cl. B25J 9/16; B25J 5/00; B25J 9/00; B25J 11/00

(52) U.S. Cl. CPC B25J 9/1666; B25J 5/007; B25J 9/0093; B25J 11/008

(57) ABSTRACT

A robot pace management system includes a manufacturing envelope within which a conveyor of a production line moves to progress product units for manufacturing tasks in producing the product. A mobile robot transports and delivers items to the manufacturing envelope. A progression indicator provides a location for each product unit as the conveyor moves. A control network with a controller determines a location for a target product unit entering the manufacturing envelope; determines a build sequence for the target product unit including the items needed for the series of manufacturing tasks for the target product unit; determines a processing timeline for the manufacturing tasks; moves the mobile robot through the manufacturing envelope in pace with the target product unit; and presents, by the mobile robot, the items to an operator of the workstation according to the build sequence and the processing timeline.

### INTRODUCTION

The technical field generally relates to manufacturing systems with moving assembly lines, and more particularly relates to a pace management system and method for a mobile robot such as an autonomous mobile robot (AMR) used in manufacturing.

In manufacturing, just-in-time (JIT) is an inventory management strategy that endeavors to deliver component parts and materials when they are needed for use in assembling a product. JIT requires advanced planning of production schedules, part and material procurement, delivery and handling. The JIT inventory strategy may be employed to improve efficiency by receiving components and materials that are actually needed and as close to the time of need as possible. Some storage of components and materials is generally required due to logistical limitations and product schedules.

After arriving at a manufacturing plant’s receiving dock, some storage of component parts and materials may be done in a warehousing/storage area of the facility and/or near workstations or line side where assembly or other processing takes place. Moving component parts and materials from the receiving dock to other locations may be done manually or through automation. One mode of movement involves transporting objects on an AMR. AMRs may be programmed to move things around a manufacturing facility, usually in quantities, from one point to another for storage until needed. When making a delivery, the AMR will place the objects in bins or racks for retrieval of individual items by an operator for use in manufacturing a product. Limitations prevent placing objects directly at a workspace. Retrieval requires the operator to expend travel time and effort that may otherwise be spent on a more productive activity.

Accordingly, there is a desire to employ JIT in a more efficient manner when delivering items to a workstation. There is also a desire to deliver items to assist the operator in various tasks. Furthermore, other desirable features and characteristics of the present disclosure will become apparent from the subsequent detailed description and the appended claims, taken in conjunction with the accompanying drawings and the foregoing introduction.

### SUMMARY

An AMR pace management system and method paces robots with assembly operations. In a number of embodiments, a robot pace management system includes a manufacturing envelope within which a conveyor of a production line moves to progress a series of product units through the manufacturing envelope. The manufacturing envelope has a series of manufacturing tasks in producing the product using items that are assembled or processed into the product units. A mobile robot transports a payload of the items and delivers the items to the manufacturing envelope. A progression indicator is readable or signal producing and provides a location for each product unit as the conveyor moves. A control network including at least one controller that: determines, through the progression indicator, a location for a target product unit entering the manufacturing envelope; determines a build sequence for the target product unit including the items needed for the series of manufacturing tasks for the target product unit; determines a processing timeline for the manufacturing tasks for the target product unit in the manufacturing envelope; moves the mobile robot through the manufacturing envelope in pace with the target product unit; and presents, by the mobile robot, the items to an operator of the workstation according to the build sequence and the processing timeline.

In additional embodiments, the controller determines when the items transported by the mobile robot are in need of restocking, and operates the mobile robot to a storage facility for the restocking of the items.

In additional embodiments, the controller maintains the mobile robot at a predefined minimum distance from the operator as the operator moves through the manufacturing envelope.

In additional embodiments, the progression indicator includes an encoder on the conveyor or a fiducial marker at a carrier of the conveyor.

In additional embodiments, the controller rotates the mobile robot to present the items to the operator according to the build sequence.

In additional embodiments, the controller determines when to replace the mobile robot with a second mobile robot.

In additional embodiments, the controller determines, from part weight of the items, when the items are in need of restocking.

In additional embodiments, the controller, when a manufacturing plant system makes a change to the build sequence and/or the processing timeline, adapts the pace and the presentation of the items.

In additional embodiments, the controller adapts a trajectory and/or a speed of the mobile robot to avoid obstacles presented in the manufacturing envelope.

In additional embodiments, the controller maintains the mobile robot at a predefined distance from the operator as the operator moves through the manufacturing envelope; and modifies the predefined distance in response to an input from the operator.

In a number of other embodiments, a method for robot pace management includes moving a conveyor of a production line through a manufacturing envelope to progress a series of product units through the manufacturing envelope. The manufacturing envelope includes a series of manufacturing tasks in producing the product units using items that are assembled or processed into the product units. A mobile robot transports a payload of the items and delivers the items to the manufacturing envelope. A progression indicator is readable or signal producing and provides a location for each product unit as the conveyor moves. A controller of a control network determines, through the progression indicator, a location for a target product unit entering the manufacturing envelope. The controller determines a build sequence for the target product unit including the items needed for the series of manufacturing tasks for the target product unit. The controller determines a processing timeline for the manufacturing tasks for the target product unit in the manufacturing envelope. A controller moves the mobile robot through the manufacturing envelope in pace with the target product unit. The mobile robot presents the items to an operator of the workstation according to the build sequence and the processing timeline.

In additional embodiments, the controller determines when the items transported by the mobile robot are in need of restocking, and operates the mobile robot to a storage facility for the restocking of the items.

In additional embodiments, the mobile robot maintains a predefined minimum distance from the operator as the operator moves through the manufacturing envelope.

In additional embodiments, the progression indicator is an encoder on the conveyor or as a fiducial marker at a carrier of the conveyor.

In additional embodiments, the mobile robot rotates and presents the items to the operator according to the build sequence.

In additional embodiments, the controller determines when to replace the mobile robot with a second mobile robot.

In additional embodiments, the controller determines, from part weight of the items, when the items are in need of restocking.

In additional embodiments, the controller adapts the pace and the presentation of the items, when a manufacturing plant system makes a change to the build sequence and/or the processing timeline.

In additional embodiments, the controller adapts a trajectory and/or a speed of the mobile robot to avoid obstacles presented in the manufacturing envelope. The controller maintains the mobile robot at a predefined distance from the operator as the operator moves through the manufacturing envelope. The controller modifies the predefined distance in response to an input from the operator.

In a number of additional embodiments, a robot pace management system, includes a manufacturing envelope within which a conveyor of a production line moves to progress a series of product units through the manufacturing envelope. The manufacturing envelope has a series of manufacturing tasks in producing the product units using items that are assembled or processed into the product units. A mobile robot transports a payload of the items and delivers the items to the manufacturing envelope. A progression indicator is readable or signal producing and provides a location for each product unit as the conveyor moves. A control network includes at least one controller that: determines, through the progression indicator, a location for a target product unit entering the manufacturing envelope; determines a build sequence for the target product unit including the items needed for the series of manufacturing tasks for the target product unit; determines a processing timeline for the manufacturing tasks for the target product unit in the manufacturing envelope; moves the mobile robot through the manufacturing envelope in pace with the target product unit; maintains the mobile robot at a predefined distance from the operator as the operator moves through the manufacturing envelope; presents, by the mobile robot, the items to an operator of the workstation according to the build sequence and the processing timeline; and collects error data during the presenting of the items to the operator.

### BRIEF DESCRIPTION OF THE DRAWINGS

The exemplary embodiments will hereinafter be described in conjunction with the following drawing figures, wherein like numerals denote like elements, and wherein:

FIG. 1 is a functional diagram of an AMR pace management system, in accordance with various embodiments;

FIG. 2 is an illustration of the AMR pace management system of FIG. 1 applied to a manufacturing system, in accordance with various embodiments;

FIG. 3 is an illustration of a workstation of the manufacturing system of FIG. 2 including aspects of the AMR pace management system, in accordance with various embodiments;

FIG. 4 is a flow chart of a method of the AMR pace management system of FIGS. 1-3, in accordance with various embodiments; and

FIG. 5 is a is a schematic illustration of an AMR of the AMR pace management system of FIGS. 1-4, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

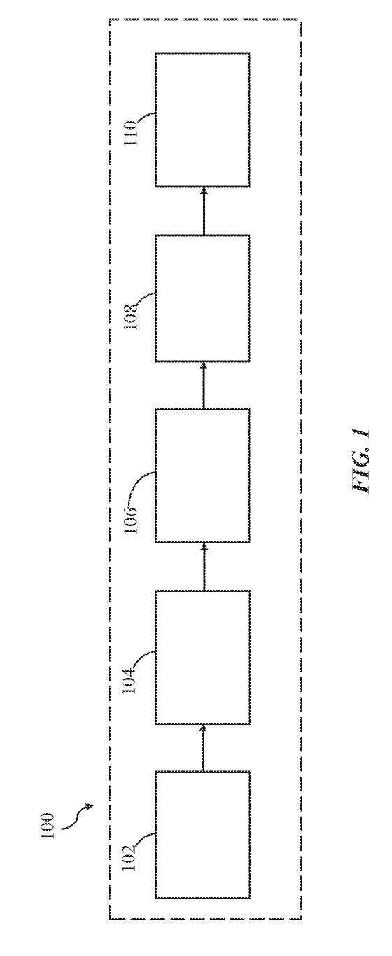

Referring to FIG. 1, illustrated is a robot pace management system that may be referred to as an AMR pace management system 100 when an AMR is used. In general, the AMR pace management system 100 delivers pinpoint time and place delivery of items to production operations with a combination of in-time and in-place delivery such as to an operator working along a moving assembly line. The items delivered to the operator may include component parts (which may be subassemblies), materials, tools and/or other things the operator needs. The AMR pace management system 100 accomplishes in-time/in-place production supply with items delivered directly to an operator precisely when the operator needs them for a defined task in standardized work. In embodiments, there is no need for component parts and materials to be stored in various containers, packages, and boxes as stationary lineside material that an assembly operator moves to and retrieves from to build the product.

The AMR pace management system 100 of FIG. 1 includes a data collection module 102 where information on the product, its required component parts and materials and operation/task timing is procured. The data and information may include a product build specification including parts/materials and sequence and may include a processing timeline. The data and information may be provided through various manufacturing plant systems. Knowing the required component parts and materials enables a stock module 104 to procure the identified items, such as through AMRs. With the items stocked, the AMR pace management system 100 moves, through a travel module 106, an AMR to a designated start position in a manufacturing envelope. The designated manufacturing envelope may be a workstation where an operator performs standardized work, or may be a segment of an assembly line with a plural number of operators and workstations. In various embodiments, an operator may be a human or may be machinery, such as a robot and/or other automated tooling.

Using the obtained build sequence and the processing timeline the AMR pace management system 100, such as via a pacing module 108, moves a stocked “”kitted” AMR in concert (paced) with a carrier/product unit on the assembly line. The movements are effected to coincide with providing the operator the right parts at the right time and in the right place via a delivery module 110. The AMR pace management system 100 avoids non-value-added walking to and from material stores to get the appropriate part(s) in the order that they are needed. The AMR pace management system 100 also improves ergonomics by presenting items to the operator in a convenient manner. The AMR tracks assembly progression with the operator as they move to assemble parts under defined standardized work. The AMR leverages the product unit’s position within a footprint to maintain alignment with the standardized work and operator position.

The AMR pace management system 100 operates within a workstation, an assembly line segment, or along an entire assembly line, any of which may be referred to as the manufacturing envelope. The AMR pace management system 100 is a dynamic system where AMR pacing enables the operator to be within arm’s reach of the components parts and material that they need at the right time. The AMR paces alongside the assembly line and the operator to be in an optimized position for the operator to retrieve any necessary parts or other items.

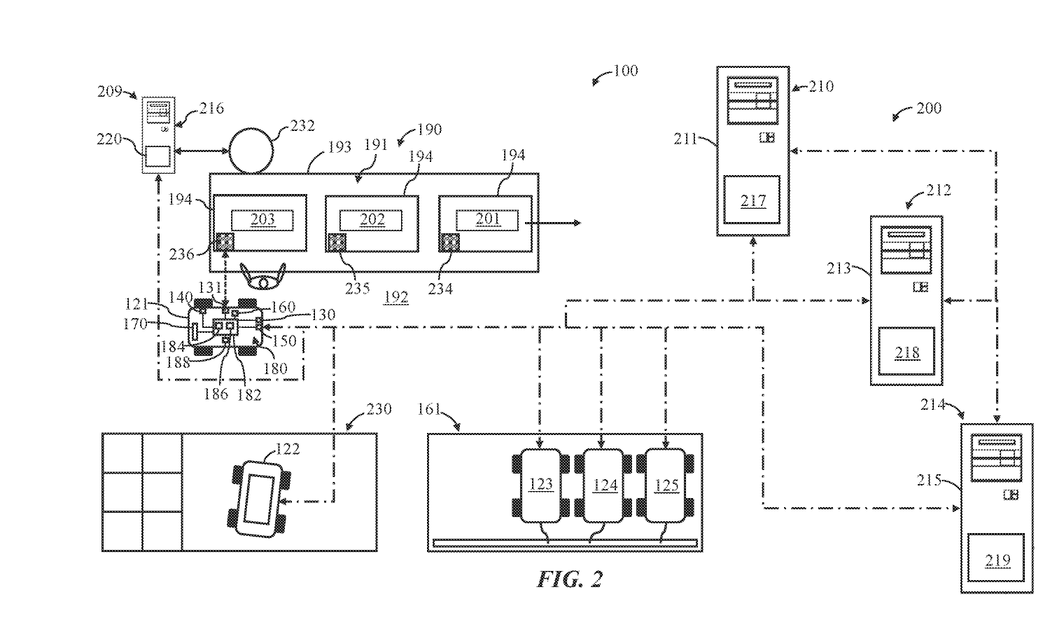

Referring to FIG. 2, the AMR pace management system 100 includes a fleet of AMRs 121-125, although any number and AMRs may be included depending on the application. Each AMR 121-125, etc. is a mobile robot and may take a variety of forms with capabilities to travel between destinations, follow routes, avoid obstacles, communicate with computer systems, sense various parameters and carry a payload. In the current embodiment, each AMR 121-125 is a full function unit operating with trackless navigation along both defined routes and with dynamic map-based path planning between destinations for autonomous route determination. In addition, the AMRs 121-125 may be configured for human-robot collaboration.

By way of example, the AMR 121 as representative of the AMRs 121-125, includes a sensor array 130 that includes any of various sensors with determinative capabilities such as vision/image, motion, position, acceleration, ranging and others. The vision capabilities may include a camera 131 as a part of the sensor array 130. The AMR 121 includes an actuator group 140 that includes any of various devices through which actions are effected such as motors, solenoids, cylinders, transmissions, drives, clamps, and others. The AMR 121 includes a communications module 150 that includes any of various devices through which information is transmitted and received wirelessly.

The communications module 150 may have both receiving and transmitting capabilities. The communications module 150 may be configured to communicate wirelessly according to one or more short-range wireless communications methods such as according to the Institute of Electrical and Electronics Engineers (IEEE) 802.11 protocols, IEEE 802.15 protocols, and others. Examples include wireless sensor networks (WSN, WSAN) and wireless local area network (WLAN). In embodiments, the communications module 150 may contain a cellular chipset enabling communication via one or more cellular protocols on cellular wide area networks (WAN). In addition, the communications module 150 may include a global navigation satellite system (GNSS) receiver to provide navigation and other position-related functions.

The AMR 121 includes a power supply module 160, such as a rechargeable energy storage system, for example a battery pack. The power supply module 160 provides energy for propelling the AMR 121 and for control other operational aspects. An AMR 121-125 in need of charging may be routed to a charging station 161. Because of the need to be recharged, the AMR 121 may be temporarily removed from service, which may be on schedule or on an as-needed basis.

The AMR 121 also includes a mechanical module 170, which may be electro-mechanical or otherwise powered. The mechanical module 170 may include structures for receiving, holding and presenting component parts, materials and supplies. In embodiments, the mechanical module 170 may include passive elements such as containers, racks, spools, and/or others. In additional embodiments, the mechanical module 170 may include active elements such as moveable arms, tilt and lift tables, conveyors, chutes, platters, turntables, and/or others.

The AMR 121 includes a control system 180 that includes a controller 182 and embedded software for carrying out various functions and features. The controller 182 comprises a computer system. The controller 182 may be one or more controllers working cooperatively. The computer system of the controller 182 includes a processor 184, a memory 186 and a storage device 188. The processor 184 performs the computation and control functions of the controller 182 and may comprise any type of processor or multiple processors, single integrated circuits such as a microprocessor, or any suitable number of integrated circuit devices and/or circuit boards working in cooperation to accomplish the functions of a processing unit. In embodiments, a plural number of processors 184 may be used in one or more controllers 182.

During operation, the processor 184 executes one or more programs contained within the memory 186 and, as such, controls the general operation of the controller 182 and the computer system of the controller 182, in executing the monitoring and control actions described herein, such as those described further below in relation to operation of the AMRs 121-125. The memory 186 stores the above-referenced program along with stored values (e.g., including, in various embodiments, map data, pacing data, spacing distances, etc.). The storage device 188 may be any suitable type of storage apparatus, including various different types of direct access storage and/or other memory devices. The storage device 188 may comprise a program product from which the memory 186 receives programs that executes one or more embodiments of one or more aspects of the present disclosure, such as the steps of the control actions described further below in connection with the illustrative embodiments.

In various embodiments, the controller 182 is coupled with the sensor array 130, the actuator group 140, the communications module 150, the power supply module 160, and the mechanical module 170. The controller 182 provides instructions for controlling the AMR 121, such as through the actuator group 140 via commands based various parameters including based on data from the sensor array 130 and information from the communications module 150. For example, the controller 182 effects navigation of the AMR 121 and to do so may be communicatively coupled to the GNSS receiver of the communications module 150. The controller may reference an on-board map database, such as in the storage device 188 that stores local map or floorplan information of the manufacturing facility.

The AMR fleet 121-125 may support a manufacturing system 190 that in this embodiment includes a moving assembly line 191 for assembling a series of a product 201-203. Each of the products 201, 202 and 203 may be referred to as a product unit. As illustrated, only a portion of the assembly line 191 is shown, for example, one workstation 192 along a part of the length of the assembly line 191 and so additional products (not shown) will be moving along the assembly line 191 at any point in time. The individual product units 201-203 may be identical or may include variations in their defined build. Each of the product units 201-203 moves along a conveyor 193 on a carrier 194. The conveyor 193 may move continuously at a set speed or may move in increments with pauses or may move at a variety of speeds over time. In embodiments, the assembly line 191 may be used to process different types of products in addition to the products 201-203.

In a control network 200, the AMR fleet 121-125, through their individual AMR communications modules 150, receive data from various off-board sources, such as manufacturing plant systems, and may transmit data to those and other sources and may otherwise communicate with those and other sources. For example, through the communications module 150, the AMR 121 communicates with an electronic pull system (EPS) 210 including a server 211 at which data resides including data on the individual product units 201-203. The AMR 121 also communicates with an assembly processing system (APS) 212 including a server 213 at which data resides including data on the various tasks associated with the manufacturing system 190. The AMR 121 also communicates with a fleet management system (FMS) 214 including a server 215 through which activities of the AMRs 121-125 are coordinated. The AMR 121 may also communicate with a conveyor controller designated as server 216 running a conveyor control system 209. It should be understood that the servers 211, 213, 215 and 216 may be one server or a server farm and/or intercommunicating units. In addition, other servers and systems may communicate with the AMR 121. Other equipment such as routers, modems, switches, or other network devices that can be used to provide networking capabilities in the control network 200. The control network 200 may be referred to as an industrial control network 200 due to the involvement of some control of physical equipment in an industrial environment and due to inclusion of the control system 180.

The servers 211, 213, 215 and 216 may be computers or other computing devices that include at least one processor and that include memory. The processors may be any type of device capable of processing electronic instructions. The processors may be dedicated processors used only for servers 211, 213, 215 and 216 or can be shared with other systems. The at least one processor can execute various types of digitally-stored instructions, such as software or firmware, which enable the servers 211, 213, 215 and 216 to provide a wide variety of services. Databases 217-220 may be stored on a plurality of memory on any suitable non-transitory, computer-readable medium of the servers 211, 213, 215 and 216, respectively.

Each product unit 201, 202 and 203 may have a unique identifier for which the EPS 210 maintains a repository of unique build specifications, including of all items that go into processing of the respective product 201-203. The EPS 210 may also maintain other relevant data such as the weight or density of each item used in the product units 201, 202, 203. This information may be in memory such as in a database 217, which may be stored at or remote from the server 211. For example, in the case of automobile assembly, each product unit 201-203 has a vehicle identification number (VIN) that is unique to the specific product 201-203 and that is associated with a build specification for that product unit 201, 202 or 203. In embodiments, the unique identifier may be a code, numbers, letters, an image, a combination thereof, or another individually identifiable representation of a product unit. The data may be supplied from the database 217 for use in the AMR pace management system 100. For example, the build specification for the product unit 202 may include an inductive charging pad as an option and the product unit 203 may not include that option. The AMR pace management system 100 extracts the build specification for the individual products 201, 202 and 203, such as they enter or are about to enter the workstation 192.

The APS 212 maintains a repository of information on the activities of the assembly line 191. For example, for the various workstations, including the workstation 192, the APS 212 has a detailed list of actions, tasks, steps, and other activities that the operator 222 is tasked with undertaking. The workstation 192 may be defined by a space or manufacturing “envelope” around the assembly line 191 where the assigned activities take place. The data, for example from the database 218, may include a description of the activity (tasks) and the time allotted for each task, such as a processing timeline within the manufacturing envelope. The time data may be based on the inputs of standardized work within specified takt time. Takt or takt time is the required product assembly duration. Takt time is a measure of the average time interval between the start of production of one unit and the start of production of the next unit during sequential production. The data may be extracted by the AMR pace management system 100, such as through the control system 180 within the control network 200. Example data may include a description such as to: “secure bolt.” The data may have a corresponding time of ten seconds allocated for the action. Similar data is included for every action of the operator 222 in the workstation 192. The AMR pace management system 100 extracts the processing timeline for the individual product units 201, 202 and 203, such as when each enters or is about to enter the workstation 192.

The FMS 214 manages the various aspects such as assignments, maintenance, charging, intercommunication and restocking of the AMRs 121-125. For the parts of the assembly line 191 serviced by the AMR fleet, the FMS 214 assigns the AMRs 121-125, etc. to a specific workstation, or other part of the assembly line 191 for which they are equipped. For example, workstations may have unique payload carrying and/or item manipulation/handling requirements for which only a part of the AMR fleet is equipped. Each assignment may have route mapping specifications that are provided to the assigned AMR. Each AMR, such as through their control system 180, may include a battery state monitor and other system health monitors for which the FMS 214 determines, via communication, that service or charging is needed. When recharging is indicated as needed, the AMR 121 may be routed to the charging station 161. When an AMR is removed from service the FMS 214 assigns another AMR to take its place. An AMR may also communicate with the FMS 214 when its stock of parts is in need of replenishing. In the case of a remote stock storage area, when the AMR travels to the restocking area 230, the FMS 214 assigns another AMR in the fleet to take its place. In anticipation of service, recharging and restocking a replacement AMR may be prepped in advance and travel to the workstation 192 to immediately step in and replace the departing AMR.

The AMR 121 communicates with the assembly line 191 to obtain information on the progression of each carrier 194 and its respective product unit 201-203. For example, an encoder 232 may be provided at the conveyor 193, such as at its drive unit, to monitor progression and provide data to the conveyor controller/server 216 of the conveyor control system 209. In an example, the progression indicator is a rotary encoder 232 that measures line speed and/or distance traveled, which is/are used in synchronizing the operation of the AMR 121. The server 216, directly or from another source such as the EPS 210, includes data on which specific product unit (e.g., 201, 202 or 203) is at which location on the assembly line 191. As a result, the AMR 121 knows where each product unit 201-203, identifiable by its unique identifier, is disposed relative to the workstation 192.

In other embodiments, or in addition to the encoder 232, the carriers 194 may each be tagged with a fiducial marker 234-236 as the progression indicator. The AMR 121, via its sensor array 130, such as through its camera 131, identifies and reads the fiducial markers (fiducials) 234-236 such as at the start of the passing of the products 201-203 into the workstation 192. The AMR 121, via the controller 182 and input from the manufacturing plant systems, recognizes the carriers 194 as marked with the fiducials 234-236 and may track their location. The AMR pace management system 100 correlates the fiducials 234-236 with the product units 201, 202, and 203, such as through the server 216, the EPS 210 and/or other data sources. The product unit 201, 202 or 203 for which the tasks of the workstation 192 will be carried out and that is identified may be referred to as the target product unit.

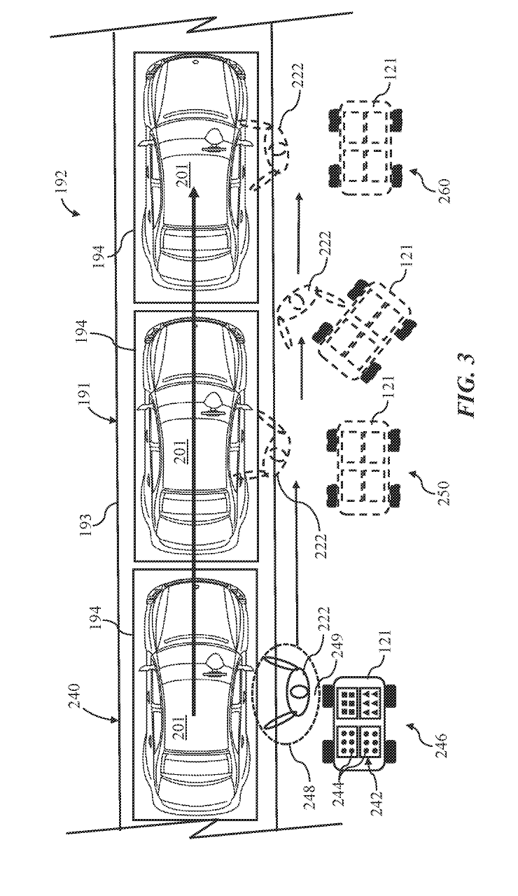

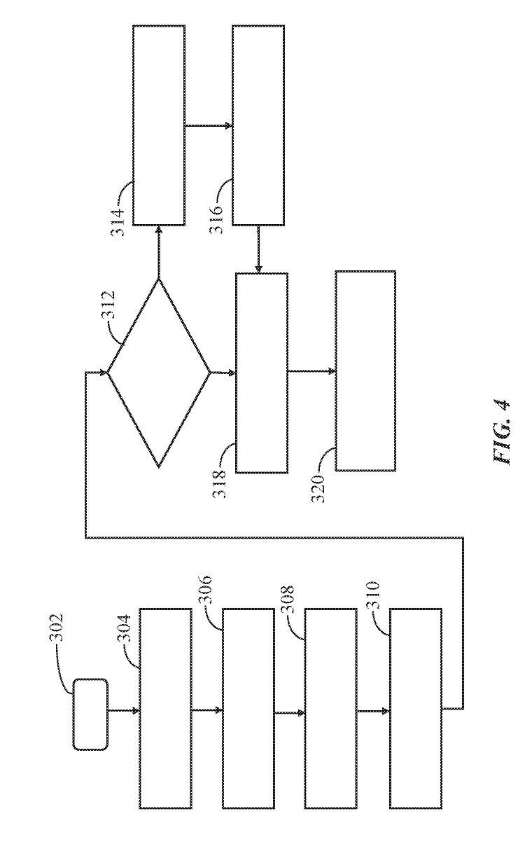

Referring to FIGS. 3 and 4, aspects of the AMR pace management system 100 and method 300 are further described. As can be appreciated, in light of the disclosure, the order of operations within the method 300 is not limited to the sequential execution as illustrated in FIG. 4 and may be performed in one or more varying orders as applicable and in accordance with the present disclosure. In addition, any of the steps may be omitted and other steps may be included. Operation of the AMR 121 may be specified for one workstation 192 or for multiple workstations of the assembly line 191.

With continuing reference to FIG. 2, as illustrated in FIG. 3 the operation is for one workstation 192. The assembly line 191 moves from left to right as shown. Specifically, the conveyor 193 and the carriers 194 move transporting the product unit 201 which is shown in three positions for descriptive purposes. It will be understood that from the workspace start position 246 the product unit 201 is moved to the right over time and may move continuously. The operator 222 is present at the entry position for working on the product unit 201. The AMR 121 carries a payload 242 that has the items 244 needed by the operator 222 for the defined tasks in manufacturing the product unit 201 at the workstation 192.

The payload 242 may be obtained in a variation of approaches. The items 244 are obtained from a location to which the AMR 121 has traveled that is not within arm’s reach of the operator 222 and would, absent the AMR 121, require physical walking to and from the cache. For example, the location may be the restocking area 230 of FIG. 2. In one option referred to as remote procurement, the restocking area 230 is at a location remote from the assembly line 191 but within the same manufacturing facility. In this case the AMR 121 travels to the restocking area 230, obtains all items 244 needed by the operator 222 for the assigned tasks in the workstation 192 and returns kitted for the work. Under this option, when the AMR 121 travels to the remote restocking area 230, a replacement AMR, such as AMR 122 will be fully stocked and take its place at the assembly line 191. In another option referred to as lineside procurement, the restocking area 230 is positioned near the assembly line 191 but out of reach of the operator 222 so that, absent the AMRs, the operator 222 would expend travel time to obtain items 244 and return to working on the product 201. The operator 222 may need to make plural trips to obtain all the items 244 needed for the tasks of the workstation 192. Instead of the operator 222 making those trips, the AMR 121 travels to, and returns from, the restocking area 230 to deliver the items to the operator 222. In this case the AMR 121 does not need to be replaced at the workstation 192 due to the shorter duration of travel. The AMR 121 may restock at times when the operator 222 is undertaking other productive tasks.

Regardless of the stocking option used, with its payload 242 the AMR 121 positions itself in a convenient place for the operator 222 and moves along the assembly line 191 with the product unit 201 and the operator 222. At the workspace start position 246 the AMR 121 uses the location of the carrier 194 (and the carried product unit 201) to position itself for the start of the assigned tasks by the operator 222. As noted above, the AMR 121 obtains the location of the carrier 194 from the progression indicator for the conveyor 193 and positions itself at a start position 246. The start position 246 is based on the position of the carrier 194 which may vary depending on the point in time that the operator completed the assigned tasks of the workstation 192 for the preceding product unit/vehicle. The start position 246 may be refined by training and learning of the AMR 121. For example, in moving to the start position 246, the AMR 121 may travel to a general percentage of the manufacturing envelope of the workstation 192 that corresponds where the product 201 is currently located.

At the start position 246 and throughout all of its movements, the AMR maintains a defined operator envelope 248 in its spacing from the operator 222 keeping a minimum distance 249 away. The operator envelope 248 may be stored in the memory 186 of the control system 180 and may be defined as a fraction of a meter. The control system 180 automatically moves the AMR 121 to maintain the operator envelope 248, including as the operator 222 moves. In embodiments, the AMR 121 may have an operator interface as part of the sensor array 130, that may be used by the operator 22sor others to adjust the size of the operator envelope 248.

As the carrier 194 moves along the assembly line 191 the AMR 121 is paced, by the control system 180, to move at the same speed. The AMR 121 also maintains the operator envelope 248 and continuously monitors the location of the operator 222 to not breach the minimum distance 249. At a point in time after the start position 246 the AMR 121 will have moved to a task zone 250. At the task zone 250, the operator 222 is working on the product 201 and the AMR 121 remains on pace with the carrier 194. The area is referred to as a “task zone” rather than a specific point because the assembly line 191 continues to move. The AMR 121 does not stay at the minimum distance 249 from the operator 222 but positions itself according to the assigned tasks and timeline so that the operator 222 may step further away from the AMR 121.

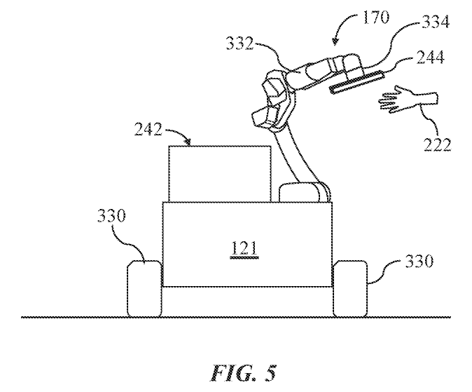

As the operator 222 completes the tasks at the task zone 250, the carrier 194 continues to move and over time advances to task zone 260. Between the assigned tasks of the operator at the task zone 250 and at the task zone 260, the operator 222 is supplied (fully or partially) with the items 244, needed by the operator. The AMR 121 may rotate or otherwise position itself to present that relevant item(s) 244 to the operator 222 in a convenient manner. This may be done in a number of ways depending on the physical characteristics of the items 244, ergonomic factors, timing, convenience, etc. In one approach, the operator 222 may pick the item(s) 244 from a bin, rack or other container. In another approach, the AMR 121, via its mechanical module 170 (FIG. 2) may present the number of item(s) needed at that time via manipulators and/or holders. This option may be referred to as “parts on a platter,” where the item(s) are presented within reach of the operator 222. In other options, the AMR 121 may physically “hand” the item(s) to the operator 222 where the item(s) are presented, such as on an arm, for the operator 222 to grasp. One specific example is described below in relation to FIG. 5.

When the operator 222 is equipped with the item(s) needed for the tasks at task zone 260 the assigned tasks may then be completed. The AMR 121 may remain on pace with the carrier 194 and stay tuned in case the operator needs another item 244. For example, the operator 222 may drop an item 244 or may have picked the wrong number of items or an incorrect item. When the allotted time for the tasks at task zone 260 are completed, the AMR 121 returns to the start position 246 aligning with the carrier 194 that is entering the workstation 192. The activities between the start position 246 and the task zone 260 may vary in a number of ways depending on the timeline, the assigned tasks and the specific product unit. Pacing of the AMR 121 with the assembly line 191 is maintained and the operator 222 is relieved of the exertion associated with travelling to obtain the items 244

The method 300 of FIG. 4 as associated with the manufacturing system 190 and the AMR pace management system 100 begins 302 and a number of preproduction activities are executed 304. These include product definition and build scheduling. This may be in response to orders or other planned product production. Data is populated in the database 217 of the EPS 210 including the build specification for each of the product units to be processed, and in the example of FIG. 3, for the product 201. The data identifies each of the items 244 that need to be available to the operator 222. Data is populated in the database 218 of the APS 212 including the activities/tasks of the assembly line 191, for example at the workstation 192. The data in the database 218 also specifies the time allotted to each action, step, process, etc. to be carried out in the assembly line 191, including at the workstation 192. Data is populated in the database 219 of the FMS 214 including data on AMR capabilities and assignments and the requirements of the assembly line 191, including at the workstation 192. Data is populated in the database 220 of the conveyor control system 209, including specification of the build order of the product and the unique identifier for each product unit to be manufactured. Each of the EPS 210, APS 212, FMS 214, the conveyor control system 209 and the AMR control system 180 are equipped with the algorithms and programs needed to effect the activities of the manufacturing system 190 and the AMR pace management system 100, including of the AMRs 121-125, etc.

The included programs represent executable instructions, used by the processors of the various systems in processing information and in controlling the manufacturing system 190 and its subsystems, including the AMR pace management system 100 and the AMRs 121-125, etc. The instructions may include one or more separate programs, each of which comprises an ordered listing of executable instructions for implementing logical functions. The instructions, when executed by the processors support the receipt and processing of inputs such as from the various hardware, and the performance of logic, calculations, methods and/or algorithms for automatically controlling the components and systems of the manufacturing system 190. In embodiments, the processor 184 may generate control signals for the AMR 121, and to automatically control various components and systems of the AMR 121, based on the logic, calculations, methods, and/or algorithms. This includes pacing the AMR 121 with the progression of the assembly line 191. In operation, when a manufacturing plant system (EPS 210, APS 212) makes a change to the build sequence and/or the processing timeline, the AMR 121, such as via the controller 182, adapts the pace and the presentation of the items.

With the systems operable, the FMS 214 deploys 306 the AMRs 121-125, etc., including assigning the AMR to workstation 192. The AMR 121 obtains the specified item(s) 244 and navigates to the start position 246. The assembly line 191 is started 308. Assembly line starting 308 may be the start of product unit 201 moving along the assembly line. The AMR 121 identifies the carrier 194 and follows the manufacturing process travelling along with the product unit 201 and at the same pace. The AMR 121 may break the pace if an obstacle is encountered or if another delay occurs but will then catch up with the progression of the product 201 based on the conveyor 193 movement and the APS 212 data.

The AMR 121 delivers 310 the item(s) 244 to the operator 222 based on the EPS 210 data and the APS 212 data. As part of the delivery 310, the AMR 121 determines its position so that the operator receives the correct item(s) 244 in the correct manner at the correct time. Accordingly, the AMR 121 maneuvers and operates any relevant system of its mechanical module 170.

The AMR 121, in coordination with the FMS 214, determines 312 whether departure from the workstation 192 is prescribed. For example, the health monitoring system may indicate a charge or other service is needed. Also for example, the item monitor may indicate restocking is needed. For example, the AMR 121 may include one or more sensors that provide signals to determine the status of the payload or parts thereof. For example weight/density data from the EPS 210 may be used in conjunction with force sensors of the sensor array 130 to determine if the payload is depleted. When the determination 312 is positive and departure is required, the AMR 121 travels 314 and a replacement AMR 122 substitutes 316 for the departing AMR 121. The monitoring may be anticipatory so that the FMS 214 ensures the AMR 122 is stocked and present lineside when the AMR 121 departs. The method 300 then continues 318, which also occurs if the determination 312 is negative but with the original AMR 121. The AMR 121/122 paces with the carrier 194 while the operator 222 completes 320 the tasks of the workstation 192. The AMR 121/122 then repositions 322 to the start position 246 and the method 300 repeats.

During the delivery 310 of the items to the operator 222 or other steps of the method 300, the AMR 121 may report to the EPS 210, or another system for error proofing purposes. For example, by monitoring the item(s) 244 as removed from the payload and the time and position of the removal, the EPS 210 may identify an error such as the removal of an incorrect item. This may be done with the weight monitoring, vision system monitoring, or another approach. The EPS 210 may flag an error that may be investigated, such as at the end of the assembly line 191 before the product unit 201 is released, or at a later time. The AMR 121-125 etc. may alternatively alert the operator 222 in real time of a suspected error for correction, if needed. The alert may be via audio or other output means, such as by the actuator group 140.

Referring to FIG. 5, an example of one system of the mechanical module 170 on the AMR 121 is illustrated. The AMR 121 is mobile on wheels 330. In other embodiments, another means of locomotion may be used. The AMR 121 carries the payload 242 of an item 244. The mechanical module 170 includes a manipulator in the form of a robot arm 332 with a gripper 334 for grasping and releasing the item 244. During the delivery 310 of the method 300, the AMR 121, via the robot arm 332, extracts the item 244 from the payload 242 and presets it to the operator 222 within the operator’s reach. The AMR 121, such as via the sensor array 130, may determine when to release the item 244, such as via force, vision, etc. The presentation of the item 244 is effected when the operator 222 is ready and at a point convenient to the operator 222.

Accordingly, robot pace management systems and methods include a mobile robot that assists with manufacturing. The robot pace management system is part of a manufacturing system that computes what items are needed by an operator, where those items are needed, and when they are needed. The mobile robot paces with a moving line and presents the items to the operator so that the operator’s need to travel for supplies is substantially reduced. Non-value added actions may be reduced and ergonomics may be improved. The mobile robot may be dedicated to a workstation or may follow an assembly line across multiple workstations in its delivery of items in-time and in-place.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A robot pace management system, comprising:
a manufacturing envelope within which a conveyor of a production line moves to progress a series of product units through the manufacturing envelope, wherein the manufacturing envelope is configured for a series of manufacturing tasks in producing the product using items that are assembled or processed into the product units;
a mobile robot configured to transport a payload of the items and to deliver the items to the manufacturing envelope;
a progression indicator that is readable or signal producing and that is configured to provide a location for each product unit as the conveyor moves; and
a control network including at least one controller configured to:
determine, through the progression indicator, a location for a target product unit entering the manufacturing envelope;
determine a build sequence for the target product unit including the items needed for the series of manufacturing tasks for the target product unit;
determine a processing timeline for the manufacturing tasks for the target product unit in the manufacturing envelope;
move the mobile robot through the manufacturing envelope in pace with the target product unit; and
present, by the mobile robot, the items to an operator of the workstation according to the build sequence and the processing timeline.

2. The robot pace management system of claim 1, wherein the at least one controller is configured to determine when the items transported by the mobile robot are in need of restocking, and operate the mobile robot to a storage facility for the restocking of the items.

3. The robot pace management system of claim 1, wherein the at least one controller is configured to maintain the mobile robot at a predefined minimum distance from the operator as the operator moves through the manufacturing envelope.

4. The robot pace management system of claim 1, wherein the progression indicator comprises an encoder on the conveyor or a fiducial marker at a carrier of the conveyor.

5. The robot pace management system of claim 1, wherein the at least one controller is configured to rotate the mobile robot to present the items to the operator according to the build sequence.

6. The robot pace management system of claim 1, wherein the at least one controller is configured to determine when to replace the mobile robot with a second mobile robot.

7. The robot pace management system of claim 1, wherein the at least one controller is configured to determine, from part weight of the items, when the items are in need of restocking.

8. The robot pace management system of claim 1, wherein the at least one controller is configured, when a manufacturing plant system makes a change to the build sequence and/or the processing timeline, to adapt the pace and the presentation of the items.

9. The robot pace management system of claim 1, wherein the at least one controller is configured to adapt a trajectory and/or a speed of the mobile robot to avoid obstacles presented in the manufacturing envelope.

10. The robot pace management system of claim 1, wherein the at least one controller is configured to:
maintain the mobile robot at a predefined distance from the operator as the operator moves through the manufacturing envelope; and
modify the predefined distance in response to an input from the operator.

11. A method for robot pace management, the method comprising:
moving a conveyor of a production line through a manufacturing envelope to progress a series of product units through the manufacturing envelope;
configuring the manufacturing envelope for a series of manufacturing tasks in producing the product units using items that are assembled or processed into the product units;
transporting, by a mobile robot, a payload of the items and delivering the items to the manufacturing envelope;
providing, by a progression indicator that is readable or signal producing, a location for each product unit as the conveyor moves;
determining, by at least one controller of a control network and through the progression indicator, a location for a target product unit entering the manufacturing envelope;
determining, by the at least one controller, a build sequence for the target product unit including the items needed for the series of manufacturing tasks for the target product unit;
determining a processing timeline for the manufacturing tasks for the target product unit in the manufacturing envelope;
moving the mobile robot through the manufacturing envelope in pace with the target product unit; and
presenting, by the mobile robot, the items to an operator of the workstation according to the build sequence and the processing timeline.

12. The method of claim 11, comprising determining when the items transported by the mobile robot are in need of restocking, and operating the mobile robot to a storage facility for the restocking of the items.

13. The method of claim 11, comprising maintaining the mobile robot at a predefined minimum distance from the operator as the operator moves through the manufacturing envelope.

14. The method of claim 11, comprising configuring the progression indicator as an encoder on the conveyor or as a fiducial marker at a carrier of the conveyor.

15. The method of claim 11, comprising rotating the mobile robot and presenting the items to the operator according to the build sequence.

16. The method of claim 11, comprising determining, by the at least one controller, when to replace the mobile robot with a second mobile robot.

17. The method of claim 11, comprising determining, from part weight of the items, when the items are in need of restocking.

18. The method of claim 11, comprising adapting, by the at least one controller, the pace and the presentation of the items, when a manufacturing plant system makes a change to the build sequence and/or the processing timeline.

19. The method of claim 11, comprising:
adapting, by the at least one controller, a trajectory and/or a speed of the mobile robot to avoid obstacles presented in the manufacturing envelope;
maintaining, by the at least one controller, the mobile robot at a predefined distance from the operator as the operator moves through the manufacturing envelope; and
modifying, by the at least one controller, the predefined distance in response to an input from the operator.

20. A robot pace management system, comprising:
a manufacturing envelope within which a conveyor of a production line moves to progress a series of product units through the manufacturing envelope, wherein the manufacturing envelope is configured for a series of manufacturing tasks in producing the product units using items that are assembled or processed into the product units;
a mobile robot configured to transport a payload of the items and to deliver the items to the manufacturing envelope;
a progression indicator that is readable or signal producing and that provides a location for each product unit as the conveyor moves; and
a control network including at least one controller configured to:
determine, through the progression indicator, a location for a target product unit entering the manufacturing envelope;
determine a build sequence for the target product unit including the items needed for the series of manufacturing tasks for the target product unit;
determine a processing timeline for the manufacturing tasks for the target product unit in the manufacturing envelope;
move the mobile robot through the manufacturing envelope in pace with the target product unit;
maintain the mobile robot at a predefined distance from the operator as the operator moves through the manufacturing envelope;
present, by the mobile robot, the items to an operator of the workstation according to the build sequence and the processing timeline; and
collect error data during the presenting of the items to the operator.
